(19) United States
(12) Patent Application Publication
(10) Pub. No.: US 2006/0109902 A1
(43) Pub. Date: May 25, 2006

(54) Compressed domain temporal segmentation of video sequences

(75) Inventors: Jon Yu, Dallas, TX (US); Fehmi Chebil, Irving, TX (US); Asad Islam, Richardson, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/993,919

(22) Filed: Nov. 19, 2004

(51) Int. Cl. H04N 7/12; H04N 11/04; H04N 9/64; H04N 5/14; H04B 1/66

(52) U.S. Cl. 375/240.12; 348/700; 375/240.24

(57) ABSTRACT

A method for detecting scene changes in a video sequence in the compressed domain. DC images are extracted from the macroblocks of the video frames. Histogram differences and pixel difference of the DC images are used for scene cut detection, and the changes in the histogram differences are used for gradual scene change detection. Thus, scene cut detection is based on first order derivatives of the histogram and gradual scene change detection is based on second order derivatives of the histogram. If the macroblocks are intra-coded, they are used to compute the exact DC images. If the macroblocks are not intra-coded, motion information in the frame is partially used for scene change detection.

### FIELD OF THE INVENTION

The present invention relates generally to video coding, video content management and, more particularly, to scene change detection in a video sequence.

### BACKGROUND OF THE INVENTION

Digital video cameras are increasingly spreading among the masses. Many of the latest mobile phones are equipped with video cameras offering users the capability to shoot video clips and send them over wireless networks.

Digital video sequences are very large in file size. Even a short video sequence is composed of tens of images. As a result, video is usually saved and/or transferred in compressed form. There are several video-coding techniques, which can be used for that purpose. MPEG-4 and H.263 are the most widely used standard compression formats suitable for wireless cellular environments.

Video contents are increasingly captured and shared between users. As more and more digital video contents become available, efficient access to the video contents for browsing, retrieval and manipulation becomes more complex. With a large volume of video contents being available, it would be advantageous to provide a means to find or catalogue what is in the content. For example, it would be useful to find video shots and key frames in the video sequence, and organize them in a table-like manner, similar to a table of contents and an index in a book. With the table of contents and index, along with a summary of video clips, retrieving and browsing of the video contents will be efficiently carried out. In order to obtain shots and key frames, for example, in a video sequence, it would be necessary to segment video data into basic access units while the video sequences are in a compressed format.

When analyzing a video clip, the first step is to segment the video in the time axis. This is basically equivalent to breaking the sequence into shots (also known as scenes). The changes from one scene to another in a video can occur in two different ways: abrupt (called scene cut) or gradual (called gradual scene change). A scene cut between two shots is illustrated in FIG. 1a. A gradual scene change is illustrated in FIG. 1b. Video compression techniques exploit spatial and temporal redundancy in the frames forming the video. Predictive coding (P or B frames) is used to represent the changes in frames (not necessarily consecutive frames). Intra coding (I frames) is used to compress frames independently.

In prior art, shot detection methods are mostly carried out in the spatial domain. More particularly, prior art methods try to detect shot boundary by monitoring the inter-frame difference. If a sufficiently large difference is found, the existence of a shot boundary is presumed. The existence of a shot boundary may mean there is a scene cut or there is a more gradual scene change. In prior art, a gradual scene change is usually considered as a special case of a scene cut.

In prior art methods, inter-frame difference is computed from RGB histogram. The RGB histogram-based methods are generally considered as the most reliable for scene cut detection (see, for example, Yeo et al. “Rapid Scene Analysis on Compressed Video”, IEEE Trans. CSVT, vol. 5, No. 6, December 1995, pp. 533-544; and Zhang et al. “Automatic Partitioning of Video”, Multimedia Systems, vol. 1(1), pp. 10-28, 1993). The RGB histogram methods are based on the assumption that if there is a scene cut, the histogram distribution of the two frames between a scene cut will be significantly different. Mathematically, the RGB histogram methods can be summarized as follows:

$$HD ( i , i + 1 ) = {\sum }_{j = 0}^{G - 1} \vert {H}_{i} ( j ) - {H}_{i + 1} ( j ) \vert \qquad ( 1 )$$

Here G is the number of bins for the histogram, and Hᵢ(j) is the number of pixels falling in bin j in frame i, and HD(i,i+1) measures the histogram distance between frames i and i+1. The scene cut detection can then be defined as follows:

$$\{ \begin{matrix}HD ( i - 1 , i ) > T , scene cut at frame i \\ HD ( i - 1 , i ) \leq T , no scene cut\end{matrix}$$

where T is a threshold value.

While this approach is generally adequate for scene cut detection, it is less successful in gradual scene change detection. Unlike a scene cut, the inter-frame difference for gradual scene changes is usually small and does not manifest any peaks.

To improve performance of RGB histogram-based methods regarding gradual scene changes, some methods model the formation of a gradual scene change. Alternatively, some explicit assumption is made during the encoding process. As such, some specific type of gradual scene changes can be detected. But when the transition between scenes is complex, which is usually the case for real video data, the performance is significantly degraded. More importantly, a priori assumptions limit the application of an algorithm that is designed around the assumptions. For example, when analyzing a video clip about a person's face, the skin tone of that person may be used for gradual scene change detection. Thus, certain assumptions about the skin tone, such as color and intensity, are used when analyzing the pixels.

It is thus advantageous and desirable to provide a method for shot detection where explicit assumptions are not required.

### SUMMARY OF THE INVENTION

The present invention provides a method for the temporal segmentation of video sequence in order to identify basic access units of videos, such as shots and key frames.

The first aspect of the present invention provides a method to detect a scene change in a video sequence in a compressed codestream, the video sequence comprising a plurality of frames in compressed domain. The method comprises:

obtaining DC images of at least part of said plurality of frames;

obtaining the histograms of the DC images based on changed parts of the frames;

computing the absolute sum of histogram difference between different DC images; and

identifying the scene change in the video sequence based on the absolute sum of histogram difference.

According to the present invention, the changed parts are identified based on coding information in the compressed domain.

According to the present invention, the frames comprise a plurality of macroblocks, and the coding information includes whether the macroblocks in the frames are inter-coded or intra-coded.

According to the present invention, the absolute sum of histogram difference is computed based on the DC images of adjacent frames in the video sequence.

According to the present invention, the scene change comprises a scene cut, and said identifying comprises applying a sliding window on the absolute sum of histogram difference over a number of consecutive frames in said plurality of frames for identifying the scene cut.

According to the present invention, the method further comprises:

computing the absolute sum of pixel difference between different DC images so that said identifying is also based on the absolute sum of pixel difference so that a slide window on the absolute sum of histogram difference and a sliding window on the absolute sum of pixel difference over a number of consecutive frames are carried out to detect the scene cut.

According to the present invention, the scene change also comprises a gradual scene change, and said identifying comprises:

computing the change of the histogram differences over a number of frames; and

detecting the gradual scene change in said number of frames based on the change of the histogram differences.

According to the present invention, the DC images are computed based on DC coefficients in a discrete cosine transform of the frames when the macroblocks of the frames are intra-coded; and

the DC images are estimated based on motion information in the frames when the macroblocks of the frames are inter-coded.

The second aspect of the present invention provides a software product embedded in a computer readable medium for use in a video coding system, the video coding system providing a video sequence in a compressed codestream, the video sequence comprising a plurality of frames in the compressed domain. The software product comprises executable codes for use in detecting a scene change in the video sequence, and the executable codes, when executed, carry out the steps of:

obtaining DC images of at least part of said plurality of frames;

obtaining the histograms of the DC images based on changed parts of the frames;

computing the absolute sum of histogram difference between different DC images; and

identifying the scene change in the video sequence based on the absolute sum of histogram difference.

According to the present invention, the frames comprise a plurality of macroblocks, the changed parts are identified based on coding information in the compressed codestream, and the coding information includes whether the macroblocks are inter-coded or intra-coded.

According to the present invention, the executable codes also carry out the step of:

computing the absolute sum of pixel difference between different DC images so that said identifying is also based on the absolute sum of pixel difference. According to the present invention, the scene change comprises a scene cut and a gradual scene change. Said identifying step comprises applying a sliding window on the absolute sum of histogram difference and a sliding window on the absolute sum of pixel difference over a number of consecutive frames in said plurality of frames for identifying the scene cut. Said identifying step comprises computing the change of the histogram differences over a number of frames and the detecting the gradual scene change in said number of frames based on the change of the histogram differences.

The third aspect of the present invention provides a method to detect a scene change in a video sequence in a compressed codestream, the video sequence comprising a plurality of frames in compressed domain, the scene change including a scene cut and a gradual scene change. The method comprises:

obtaining DC images of at least part of said plurality of frames;

obtaining histograms of the DC images based on changed parts of the frames identified based on coding information in the compressed codestream;

computing first order derivatives of the histograms and second order derivatives of the histograms; and

identifying the scene cut based on the first order derivatives and identifying the gradual scene change based on the second order derivatives.

According to the present invention, the frames comprise a plurality of macroblocks and the coding information comprises information whether the macroblocks in the frames are inter-coded or intra-coded and wherein the DC images are obtained also based on the coding information.

The fourth aspect of the present invention provides a device for use in a video coding component providing a video sequence in a compressed domain, the video sequence comprising a plurality of frames, said device comprising:

a first device part, responsive to video sequence in the compressed domain, for providing DC images of at least part of said plurality of frames;

a second device part, responsive to the DC images, for obtaining histograms of the DC images based on changed parts of the frames;

a third device part, responsive to the histograms, for computing the absolute sum of histogram difference between different DC images so as to identify a scene change in the video sequence at least partly based on the absolute sum of histogram difference.

According to the present invention, the video sequence is obtained from a compressed codestream, and wherein the changed parts of the frames are identified based on coding information from the compressed domain.

According to the present invention, the frames comprise a plurality of macroblocks and the coding information comprises information indicating whether the macroblocks in the frames are inter-coded or intra-coded.

According to the present invention, the absolute sum of histogram difference is computed based on DC images of adjacent frames in the video sequence.

According to the present invention, the scene change comprises a scent cut, and the third device part comprises means for applying a sliding window on the absolute sum of histogram difference over a number of consecutive frames in said plurality of frames for identifying the scene cut.

According to the present invention, the third device part also computes the absolute sum of pixel difference between different DC images so that said identifying is also based on the absolute sum of pixel difference.

According to the present invention, the absolute sum of histogram difference and the absolute sum of pixel difference are computed based on DC images of adjacent frames in the video sequence.

According to the present invention, the scene change comprises a scene cut, and said identifying comprises applying a sliding window on the absolute sum of histogram difference and a sliding window on the absolute sum of pixel difference over a number of consecutive frames in said plurality of frames for identifying the scene cut.

According to the present invention, the scene change comprises a gradual scene change, and said identifying comprises:

computing the change of the histogram differences over a number of frames; and detecting the gradual scene change in said number of frames based on the change of the histogram differences.

The temporal segmentation method, according to the present invention, is applicable to video sequences compressed using a hybrid block-based video coding scheme, such as MPEG-2, H.263, MPEG-4, AVC and the like.

The present invention will become apparent upon reading the description taken in conjunction with FIGS. 1a to 6.

### BRIEF DESCRIPTION OF THE DRAWINGS

FIG. 1a is a schematic representation showing a scene cut between two shots in a video sequence.

FIG. 1b is a schematic representation showing a gradual scene change between two shots in a video sequence.

FIG. 2a is a schematic representation showing a video segment being reclassified in a gradual change detection procedure.

FIG. 2b is a schematic representation showing motion information is used in classification of a video segment in the gradual change detection procedure.

FIG. 2c is a schematic representation showing another step in the gradual change detection procedure.

FIG. 3 is a flowchart showing the compressed domain temporal segmentation of a video sequence, according to the present invention.

FIG. 4 is a flowchart showing a method of scene cut detection, according to the present invention.

FIG. 5 is a schematic representation showing a software module for use in scene change detection, according to the present invention.

FIG. 6 is a block diagram showing a software/hardware module operatively connected to a video decoder for carrying out compressed domain temporal segmentation of video sequences, according to the present invention.

### DETAILED DESCRIPTION OF THE INVENTION

The method for temporal segmentation of video sequences, according to the present invention, is based on scene change detection in the compressed domain. In particular, abrupt scene changes such as a scene cut and gradual scene changes are treated differently. Scene cut detection, according to the present invention, is based on first-order derivative calculations, wherein gradual scene change detection is based on second-order derivative calculations. While the first-order calculations involve comparison of the inter frame absolute difference of certain features between two frames, the second-order calculations take into account the change pattern over a period covering all frames in a small range.

The present invention also makes use of a modified histogram measure that takes spatial information into consideration. The modified histogram measure integrates spatial information in histogram counting.

Scene Cut Detection

Shot detection in the compressed domain can be classified into two categories: DC image based and motion information based.

A DC image refers to the image formed only by using DC coefficients, or the F(0,0) terms in the Forward Discrete Cosine Transform (FDCT), of the original image. If P(x,y) is a pixel of the original image, then the DC image of the original image is given by:

$${IMG}_{dc} ( i , j ) = \frac{1}{64} {\sum }_{m = 8 i}^{8 i + 7} {\sum }_{n = 8 j}^{8 j + 7} P ( \dot{m} , n ) \qquad ( 2 )$$

Thus, the intensity of the pixel in the DC image is actually the average intensity of the corresponding DCT blocks in the original image. As can be seen in the above equation, the DC image is reduced by a factor of 64 as compared to the original image. However, this reduced image still retains the global information of the original image. For that reason, it is possible to use DC images for scene cut detection in the original video sequence while significantly reducing the computational requirements. For I frames, exact DC images can be extracted for scene cut detection. It should be noted that Equation 2 is given for an 8×8DCT. In AVC (Advanced Video Coding), for instance, a 4×4DCT is used and the DC image is reduced by a factor of 16 as compared to the original image. In general, the present invention is applicable to an N×NDCT, wherein N is an integer equal to or greater than 2.

For P frames and B frames, however, extraction of DC images requires full decoding of the entire bitstream. This requirement usually cannot be met in mobile applications because high computational complexity is usually required. In order to avoid full decoding, DC images of intra-coded macroblocks are used because they can be reconstructed exactly. For inter-code macroblocks, DC images can only be obtained by approximation. The approximated DC images are useful in decoding of motion vectors of the macroblocks.

Thus, scene cut detection in I frames and in P frame is carried out differently. With I frames, scene cut detection is carried out as follows:
1) Obtain a DC image for each frame and calculate the histogram for the DC image;
2) For every two successive DC images for k and k+1 frames, calculate the absolute sum of the histogram difference, or HDₖ^{DC}, and the absolute sum of the pixel difference, or PDₖ^{DC};
3) Apply a sliding window on PDₖ^{DC} to select the scene cut candidates.
4) Apply a sliding window on HDₖ^{DC} to confirm the existence of the scene cut candidates as picked out in Step 3; and

5) Compare the background (unchanged) regions of frame k and frame k+2 to further make sure there is a scene cut.

In Steps 3 and 4 above, a window size of W=7 gives a window of 7 frames. With video clips having a frame rate of 15 frames/second, this window size lasts about one half second. When the sliding window is applied on the absolute sum of pixel difference and the absolute sum of histogram difference, weak local peaks not actually associated with a scene cut may occur. In order to prevent weak local peaks from being identified as scene cuts, a global threshold is used to set a lower limit to the peak value in the sliding window. For example, it is possible to use a value n as a threshold for peak detection in Step 3 as follows:

Let W, an odd positive integer, be the window size, then there is a peak or a scene cut candidate in frame k if
PDₖ^{DC}≧nPDⱼ^{DC},
where
k−(W−1)/2≦j≦k+(W−1)/2; j≠k
Likewise, we confirm the existence of the scene cut candidate in Step 4 using the same threshold:
HDₖ^{DC}≧nHDⱼ^{DC}
The value n can be 2, for example.

When the frame k+1 is an I frame, peaks are usually shown in the HDₖ^{DC} and the PDₖ^{DC} sequences in the sliding window application. However, many of those peaks may be the result of the accumulated error in approximated DC computation for the inter-coded MBs because too few I-frames are available to update the approximated DC. For that reason, Step 5 is used to compare the unchanged regions of frame k and frame k+2, assuming the current I-frame is frame k+1. If there is no scene cut from frame k to frame k+1, then it can be safely assumed that most background regions in frame k and frame k+2 are the same—only the foreground regions are changed. The comparison of unchanged regions can be carried out as follows:

Let NA=0. For every MB in frame k+2, if MB is intra-coded or unchanged, it is compared with the corresponding MB (of the same location) in frame k. If the corresponding MB is not intra-coded or unchanged but it is changed (motion-compensated with non-zero motion vector), then NA is increased by 1. If the corresponding MB is intra-coded or unchanged, the NA is decreased by 1. After all MBs in frame k+2 are compared with the corresponding MBs in frame k, we compute NA/NS. If (NA/NS) is smaller than a threshold value, no scene cut is assumed. Here NS is the total number of MBs in a frame. For example, this threshold value can be set at 0.4.

With P frames, scene cut detection is carried out as follows:
1) Obtain a DC image for each frame if the macroblock in that frame is intra-coded and calculate the histogram for the DC image.
2) For every two successive DC images for k and k+1 frames, calculate the absolute sum of the histogram difference, or HDₖ^{DC}, and the absolute sum of the pixel difference, or PDₖ^{DC}—only the intra-coded MB is used in the calculation.
3) Apply a sliding window on PDₖ^{DC} to select the scene cut candidates.
4) Apply a sliding window on HDₖ^{DC} to confirm the existence of the scene cut candidates as picked out in Step 3; and
5) Apply a scene change validation test to remove possible false detection.

With P frames, an addition validation test is provided in Step 5. A potential problem associated with P frames is that, if frame k+1 is a P frame, the encoder cannot find similar regions in frame k for most MBs in frame k+1. As a result, most MBs in frame k+1 are intra-coded. That is why inter-coded MBs in P frames are ignored in the calculation of PDₖ^{DC} and HDₖ^{DC}. If NIₖ₊₁ is the number of intra-coded MBs in frame k+1 and NS is the total number of MBs in a frame, we define a measure Rₖ₊₁=NIₖ₊₁/NS such that when Rₖ₊₁ is smaller than a threshold value, no scene cut is assumed. A threshold value of 0.5 can be used, for example.

Gradual Scene Change Detection

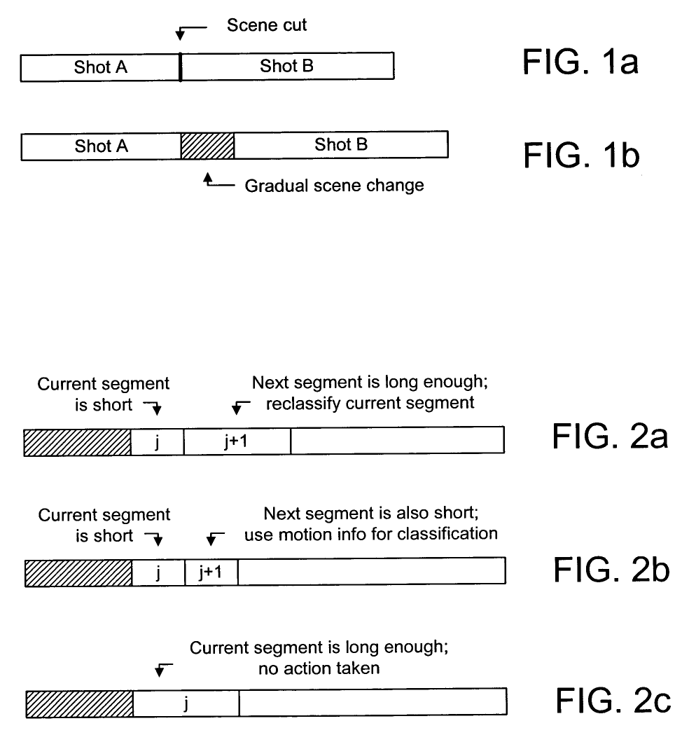

For simplicity, we define a shot as an image sequence with a substantially unchanged background. If Shot A is succeeded immediately by another Shot B, then a scene cut is said to occur between the last frame of Shot A and the first frame of Shot B (see FIG. 1a). However, if the transition from Shot A to Shot B is not clear-cut but is a gradual processing involving several images, then this gradual shot transition is called a gradual scene change or SGC (see FIG. 1b).

Abrupt scene cuts and gradual scene changes are different transitions and need to be treated differently. For an abrupt scene cut, if we move the first several frames of Shot B to a location somewhere in Shot A, a human observer will be able to detect a scene cut at that new location. However, if we move several gradual change frames to a new location, whether a human observer detects a new gradual scene change depends on how many frames are moved. If we reposition only a few (two, for example) gradual scene change frames, then a human viewer is not likely to detect any changes. Thus, it can be stated that a scene cut is a single-frame based feature while a gradual scene change is a multi-frame based feature. Therefore, a different approach should be used to localize gradual scene changes.

In detecting an abrupt scene cut, as discussed earlier, we are essentially testing whether two frames are different enough to be in different shots. But in detecting a gradual scene change, simple comparison between two frames is usually not enough. This is because the difference between two successive frames in a gradual scene change sequence is usually small even if these frames are not in the same shot.

In scene cut detection, the problem is how to classify continuous frames into different shots. In GSC detection, the problem becomes one of classifying all frames into two categories: shot boundary (GSC) or shot, and whether a frame is a GSC frame (changing) or a shot frame (non-changing) must be determined.

For any frame i, a metric indicating the histogram change trend of frame i is defined as follows:

$$GSC ( i ) = \frac{{\sum }_{j = i}^{i + GS} {MHD}^{DC} ( j , j + 1 ) - {max}_{j = i , ⋯ , i + GS} \{ {MHD}^{DC} ( j , j + 1 ) \}}{{HD}^{DC} ( i , i + GS + 1 )} \qquad ( 3 )$$

where

MHD^{DC}(j,j+1) is the modified histogram difference between frames j and j+1, i.e., the histogram is only counted for changed MBs of frame j+1;

HD^{DC}(i,i+GS+1) is the typical histogram difference between frame i and frame i+GS+1. Here, the histogram is counted for the entire frame; and

GS is a positive integer, usually between 6 to 12, but can be smaller or greater.

If there is no scene change between frames j and j+1, then MHD^{DC}(j,j+1) will assume a value close to 0. If GS is a reasonably large number, then the value of HD^{DC}(i,i+GS+1) is usually large. Thus, if there are no gradual scene changes ahead of frame i, GSC(i) usually is very small and is close to 0. If there is a gradual scene change ahead of frame i, GSC(i) usually is close to 1. However, because the value of GSC(i) is generally dependent upon the integer GS chosen for gradual scene change detection, the GSC(i) can be smaller than 0.5 but can also be greater than 1, when there is a gradual scene change.

It is possible to use Equation 3 to quantify the change of inter-frame histogram difference. Because HD^{DC}(j, k) and MHD^{DC}(j, k) are values derived from a first order differential, GSC(i) can be treated as a value derived from a second order differential. A second order differential is usually used to detect smooth transitions whereas the first order differential is used to detect abrupt changes.

It should be noted that a scene cut, in general, does not affect the value of GSC(i) because of the subtraction of the first term in Equation 3 by the largest histogram difference in the window under investigation. Because the largest histogram difference arises from the scene cut, the contribution of the scene cut in the first term is taken out by the largest histogram difference. For that reason, the occurrence of a scene cut does not degrade the gradual scene change detection. This subtraction also reduces the influence of noise.

Upon GSC(i), entropic thresholding is applied to obtain an automatic threshold T_{GSC}. For any frame j, if GSC(j)>T_{GSC}, then it is assumed to be a GSC frame (shot boundary or inter-shot frame). Otherwise, it's a shot (or intra-shot) frame. We assign every GSC frame with a label 2 and all other frames with a label 0. Entropic thresholding is described in Yu et al. (“An efficient method for scent detection”, Pattern Recognition Letters, vol. 22, pp. 1379-1391, 2001). Entropic thresholding is very useful in two-class classification. It can be used to adapt the threshold to the specific input by maximizing the entropy of the input data.

The above-disclosed method is a forward detection of GSC and it can detect the first frame (head) of a GSC sequence. However, the forward detection method will not detect the last frame (tail) of the GSC sequence. Thus, it is desirable also to take a backward measure, such that GSC_B(i)=GSC(i−GS−1). By thresholding GSC_B(i), the tail of GSC sequence can be recovered.

In order to extract GSC, a post-processing procedure is required. The procedure is illustrated in FIGS. 2a-2c. It is similar to the post-processing procedure in image segmentation where over-segmented objects of a very small size will be eliminated. In the present invention, post-processing is used to eliminate GSC or shot segments with a very small length. The procedure is carried out in three steps:
a. For any frame that is detected as an isolated shot frame, it is reclassified as a GSC frame. A shot frame j (label 0) is considered as an isolated shot frame when both frame (j−1) and frame (j+1) are SGC frames;
b. All continuous frames with the same signature will be merged to form a preliminary video sequence, and the number of frames (the length) in that segment is counted. The signature, as used here, can be taken as the label. If the length is greater than a predetermined value, no further action will be taken (see FIG. 2c). Otherwise, merging is performed in order to eliminate small regions in image segmentation. For any video segment k whose length is smaller than the predetermined value, the length of the segment k+1 is determined. If the length of the segment k+1 exceeds the predetermined value (see FIG. 2a), the type of all frames in the current segment k will be changed—SGC frames will be re-classified as shot frames and vice versa. However, if the length of the segment k+1 is equal to or smaller than the predetermined value (see FIG. 2b), motion information will be used to determine whether the frames in the current segment k are shot frames or GSC frames. In the latter case, the number of unchanged MBs in each of the frames in the current video segment k is counted, and the total number is divided by the number of frames in the video segment to obtain a number MBC(k). If MBC(k) exceeds a threshold value, indicating the current segment being under motion, the frames are classified as GSC frames. Otherwise, the frames are classified as shot frames. The predetermined value and the threshold value, in general, are set according to the frame rate and the image size in the video sequence. For example, if the frame rate is 30 frames/second and the image size is 176×144 pixels or 99 macroblocks, a predetermined value of 15 can be used. The threshold value for MBC(k) can be set at half the number of macroblocks per frame, or 49.
c. The predetermined value of the sequence length is increased to a new value, and MBC(k) is again computed. The new value can be twice the original predetermined value, for example. If the newly obtained MBC(k) exceeds the threshold value, the frames are classified as GSC frames. Otherwise, the frames are classified as shot frames.

Finally, a changed part validation test is used to confirm the detected GSC. It's essentially same as the procedure described in Steps b and c above but with a smaller threshold.

The temporal segmentation method, according to the present invention, can be carried out as follows:
1. First, scene cut detection will assign each frame with a label, which is either 1 or 0. If a frame is the first frame of a new shot, then its label is 1; otherwise, its label is 0. Referring to FIG. 1, the first frame of shot B will be labeled 1 while all other frames of B will be labeled 0.
2. A GSC detection module will also assign a label to each frame. All GSC frames will be labeled 2 while all other frames will have label 0;
3. For all frames whose labels are 0 by scene cut detection, if their labels by the GSC detection module are 2, their labels are kept as 2. Otherwise, their final signatures remain 0. For those frames whose label is 1 by scene cut module, their final labels remain the same.

The final result can be interpreted in this way: For any frame whose label is 1, there is a scene cut. Any frame with label 2 is a GSC frame, whereas a shot frame has label 0.

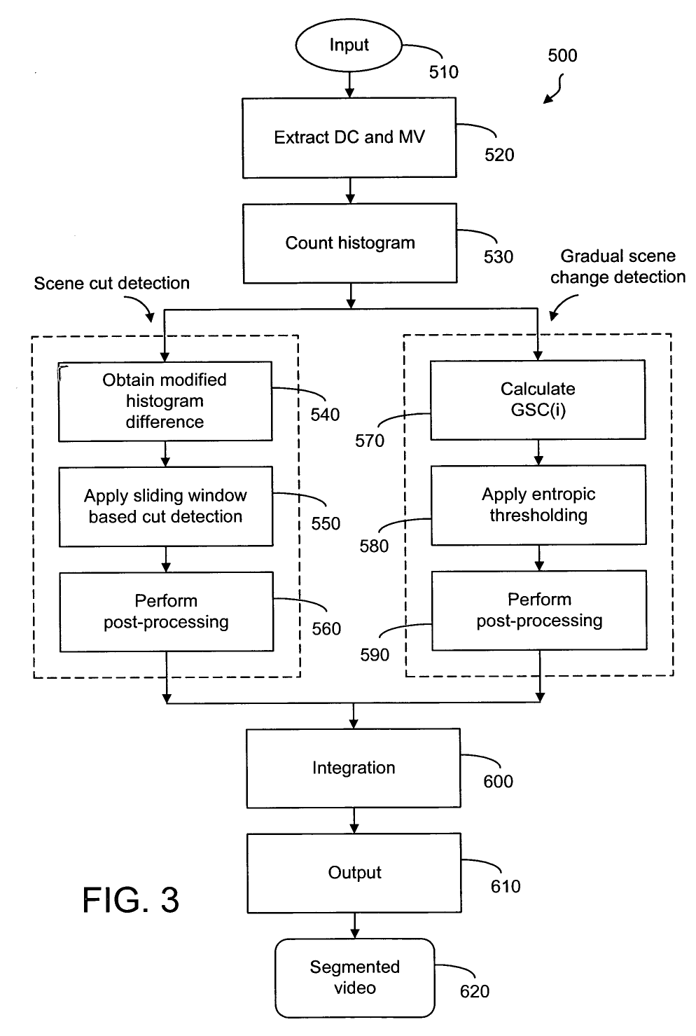

The flowchart for the overall shot detection is shown in FIG. 3. Note that exact DCs from intra-coded MBs and motion vectors from inter-coded MBs are the only information needed by the detection algorithm. Thus, the computational complexity of the temporal segmentation, according to the present invention, is generally very low.

The method of scene change detection, according to the present invention, is summarized in FIG. 3. As shown in the flowchart 500, the compressed video data is received at step 510. At step 520, it is determined whether the macroblocks are intra-coded or inter-coded. If the MBs are intra-coded, then exact DC images are obtained. Otherwise motion vectors and approximated DC images are obtained. At step 530, histograms for the DC images are computed. At this stage, scene cut detection and graduate scene change detection are carried out using different procedures. In scene cut detection, modified histogram differences are computed at step 540 and a sliding window is used to identify a frame with a scene cut at step 550. At step 560, further processing is carried out to make sure there is a scene cut. In gradual change detection, a positive number GS is selected and the metric indicating the trend of histogram change is computed at step 570. A two-class classification using entropic thresholding is carried out at 580 in order to detect a gradual scene change. A post-processing step 590 is used to extract gradual scene change information. Based on the scene cut and gradual scene change detection results, frames are labeled at step 600 and scene change information is provided at step 610. Based on the information, a video sequence can be segmented at step 620.

In gradual scene change detection, the post-processing step 590 is carried out to measure to length of the gradual scene change sequence, using a frame labeling procedure.

The scene cut detection as carried out in steps 540 to 560 in the flowchart 500 can be further elaborated as follows: The absolute sum of the histogram difference for every two successive DC images is calculated at step 542 and the absolute sum of the pixel difference is calculated at step 544. A sliding window is separately applied on the pixel difference and on the histogram difference at step 552 and step 554.

The further processing procedure at step 560 involves many sub-steps: First, a value of NA is computed at step 562 based on whether the MBs are intra-coded and whether they are changed. Second, the ratio of NA to the total number of MBs is computed and compared to a threshold T₁. If the ratio is smaller than the threshold, no scene cut is assumed. If the ratio is greater than the threshold, then further processing depends upon whether the frame is an I frame or a P frame (step 564). If the frame is an I frame, then a scene cut is assumed. Finally, if it is a P frame, a value of NIₖ₊₁ is computed at step 566 based on whether the MBs are inter-coded or intra-coded. The ratio of NIₖ₊₁ to the total number of MBs is computed and compared to a threshold T₂. Whether there is a scene cut in the P frame is determined accordingly.

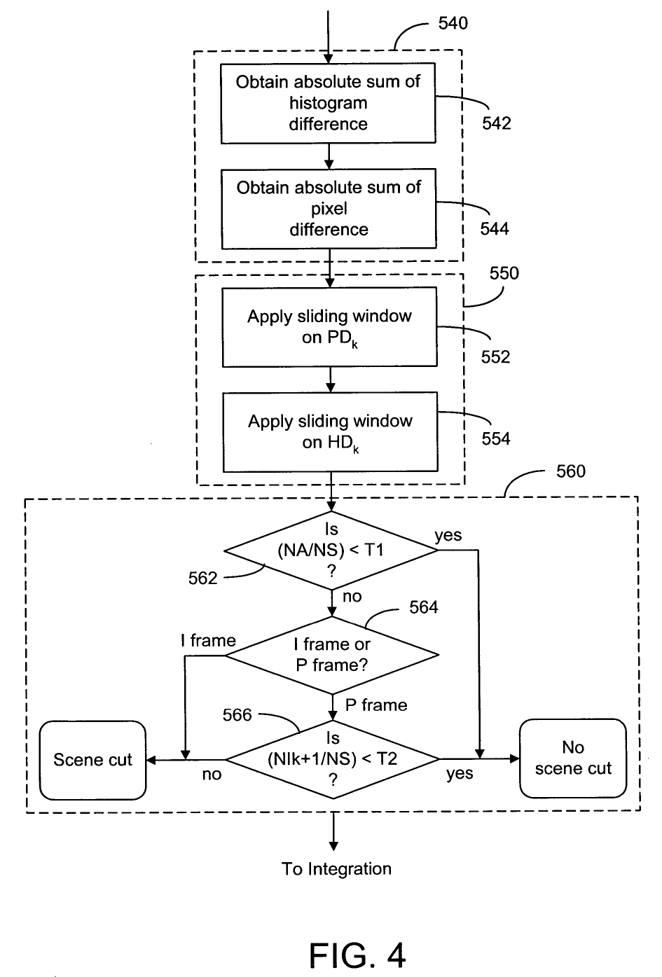

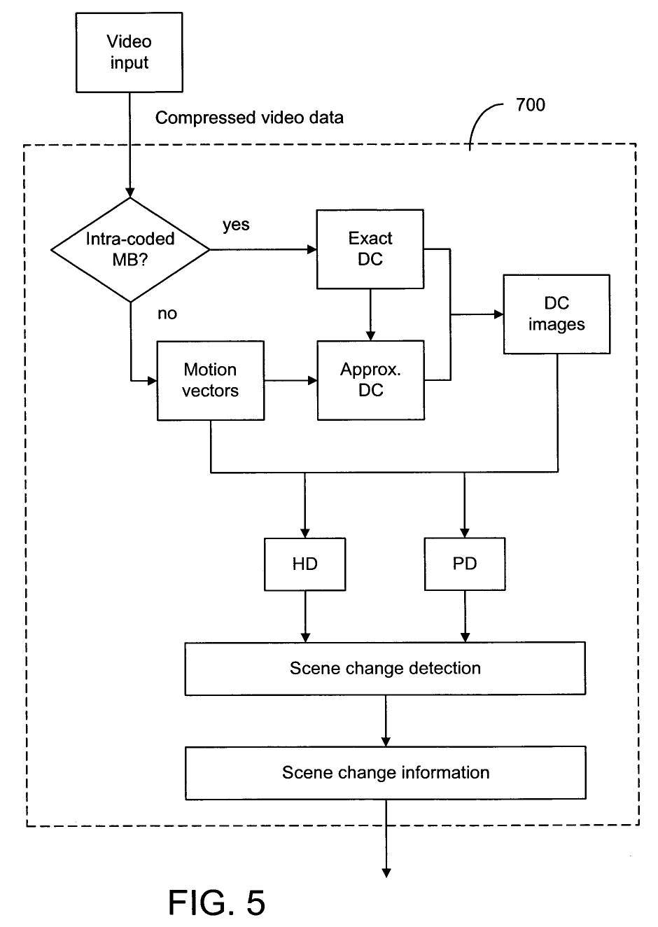

The method of detecting scene changes in a video sequence, can be carried out using a software program in a software module 700 as shown in FIG. 5. The software module is operatively connected to the video sequence in the compressed domain, either in an encoder or a decoder. The software module has executable codes embedded in a computer readable medium. When executed, these codes can carry out the method steps as shown in FIGS. 3 to 5.

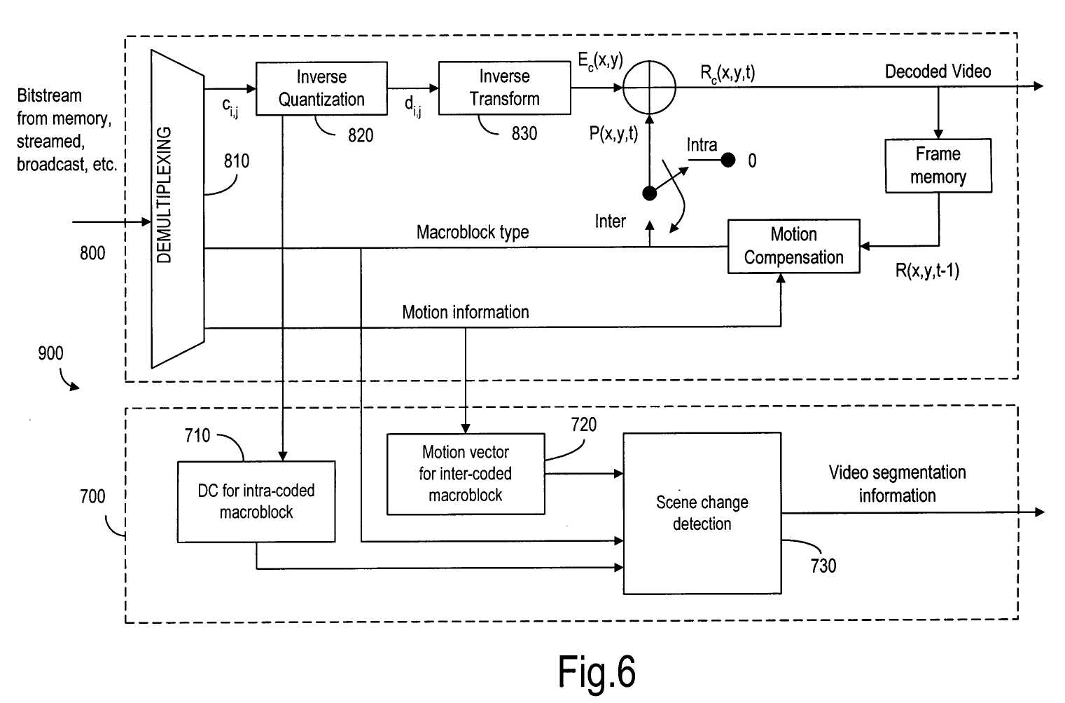

The method of temporal segmentation of video sequences, according to the present invention, can be used in conjunction with a decoder or an encoder. FIG. 6 is a block diagram illustrating an example of a hardware module or software program operatively connected to a decoder for temporal segmentation of video sequences. As shown, the video coding system 900 comprises a decoder 800 and a video segmentation software/hardware module 700. The decoder 800 operates on a multiplexed video bit-stream (includes video and audio), which is demultiplexed via a demultiplexer 810 to obtain the compressed video frames. The bitstream can be conveyed from a memory storage device or from a video encoder, but it can be a broadcast bitstream via a wireless network. The compressed data comprises entropy-coded-quantized prediction error transform coefficients, coded motion vectors and macro block type information. The decoded quantized transform coefficients c(x,y,t), where x, y are the coordinates of the coefficient and t stands for time, are inverse quantized to obtain transform coefficients d(x,y,t) according to the following relation:
d(x,y,t)=Q⁻¹(c(x,y,t))
where Q⁻¹ is the inverse quantization operation via an inverse quantization module 820. In the case of scalar quantization, the above equation becomes
d(x,y,t)=QPc(x,y,t)
where QP is the quantization parameter. In the inverse transform block 830, the transform coefficients are subject to an inverse transform to obtain the prediction error E_{c}(x,y,t):
E_{c}(x,y,t)=T⁻¹ (d(x,y,t))
where T⁻¹ is the inverse transform operation, which is the inverse DCT in most compression techniques.

If the block of data is an intra-type macro block, the pixels of the block are equal to E_{c}(x,y,t). In fact, as explained previously, there is no prediction, i.e.:
R(x,y,t)=E_{c}(x,y,t)
If the block of data is an inter-type macro block, the pixels of the block are reconstructed by finding the predicted pixel positions using the received motion vectors (Δₓ,Δ_{y}) on the reference frame R(x,y,t−1) retrieved from the frame memory. The obtained predicted frame is:
P(x,y,t)=R(x+Δₓ,y+Δ_{y},t−1)
The reconstructed frame is
R(x,y,t)=P(x,y,t)+E_{c}(x,y,t)
The operation carried out in the decoder 800 is known in the art. According to the present invention, the motion information and the information on macroblock type from the demultiplexer 810 can be conveyed to the software/hardware module 700 so that approximated DC can be obtained (see FIG. 5). Based on the conveyed information, motion vector for inter-coded macroblock can be stored in a module 710. Furthermore, the DC coefficients can be obtained from the inverse quantization module 820. The DC coefficients are stored in module 720. Based on the DC coefficients, the macroblock type information and the motion vector, a software/hardware module 730 is used to provide video segmentation information so as to produce temporal segmentation components.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method to detect a scene change in a video sequence comprising a plurality of frames in the compressed domain, said method comprising:
obtaining DC images of at least part of said plurality of frames;
obtaining the histograms of the DC images based on changed parts of the frames;
computing the absolute sum of histogram difference between different DC images; and
identifying the scene change in the video sequence based on the absolute sum of histogram difference.

2. The method of claim 1, wherein the video sequences are embedded in a compressed codestream, and the changed parts are identified based on coding information from the compressed codestream.

3. The method of claim 2, wherein the frames comprise a plurality of macroblocks and the coding information comprises information indicating whether the macroblocks in the frames are inter-coded or intra-coded.

4. The method of claim 1, wherein the absolute sum of histogram difference is computed based on DC images of adjacent frames in the video sequence.

5. The method of claim 4, wherein the scene change comprises a scene cut, and said identifying comprises applying a sliding window on the absolute sum of histogram difference over a number of consecutive frames in said plurality of frames for identifying the scene cut.

6. The method of claim 1, further comprising:
computing the absolute sum of pixel difference between different DC images so that said identifying is also based on the absolute sum of pixel difference.

7. The method of claim 6, wherein the absolute sum of histogram difference and the absolute sum of pixel difference are computed based on DC images of adjacent frames in the video sequence.

8. The method of claim 7, wherein the scene change comprises a scene cut, and said identifying comprises applying a sliding window on the absolute sum of histogram difference and a sliding window on the absolute sum of pixel difference over a number of consecutive frames in said plurality of frames for identifying the scene cut.

9. The method of claim 7, wherein the scene change comprises a gradual scene change, and said identifying comprises:
computing the change of the histogram differences over a number of frames; and
detecting the gradual scene change in said number of frames based on the change of the histogram differences.

10. The method of claim 1, wherein each frame comprises a plurality of macroblocks and wherein
the DC images are computed based on DC coefficients in a transform of the frames when the macroblocks of the frames are intra-coded; and
the DC images are estimated based on motion information in the frames when the macroblocks of the frames are inter-coded.

11. A software product embedded in a computer readable medium for use in a video coding system, the video coding system providing a video sequence comprising a plurality of frames in the compressed domain, wherein the software product comprises executable codes for use in detecting a scene change in the video sequence, and the executable codes, when executed, carry out the steps of:
obtaining DC images of at least part of said plurality of frames;
obtaining the histograms of the DC images based on changed parts of the frames;
computing the absolute sum of histogram difference between different DC images; and
identifying the scene change in the video sequence based on the absolute sum of histogram difference.

12. The software product of claim 11, wherein the video sequences are obtained from a compressed codestream, and the changed parts are identified based on coding information from the compressed codestream.

13. The software produce of claim 12, wherein the frames comprise a plurality of macroblocks and the coding information comprises information indicating whether the macroblocks in the frames are inter-coded or intra-coded.

14. The software produce of claim 11, wherein the executable codes also carry out the step of:
computing the absolute sum of pixel difference between different DC images so that said identifying is also based on the absolute sum of pixel difference.

15. The software produce of claim 14, wherein the absolute sum of histogram difference and the absolute sum of pixel difference are computed based on DC images of adjacent frames in the video sequence.

16. The software product of claim 15, wherein the scene change comprises a scene cut, and said identifying comprises applying a sliding window on the absolute sum of histogram difference and a sliding window on the absolute sum of pixel difference over a number of consecutive frames in said plurality of frames for identifying the scene cut.

17. The software product of claim 16, wherein the scene change comprises a gradual scene change, and said identifying step comprises:
computing the change of the histogram differences over a number of frames; and
detecting the gradual scene change in said number of frames based on the change of the histogram differences.

18. The software product of claim 11, wherein each frame comprises a plurality of macroblocks and wherein
the DC images are computed based on DC coefficients in a transform of the frames when the macroblocks of the frames are intra-coded; and
the DC images are estimated based on motion information in the frames when the macroblocks of the frames are inter-coded.

19. A method to detect a scene change in a video sequence in a compressed codestream, the video sequence comprising a plurality of frames in compressed domain, the scene change including a scene cut and a gradual scene change, said method comprising:
obtaining DC images of at least part of said plurality of frames;
obtaining histograms of the DC images based on changed parts of the frames identified based on coding information in the compressed codestream;
computing first order derivatives of the histograms and second order derivatives of the histograms; and
identifying the scene cut based on the first order derivatives and identifying the gradual scene change based on the second order derivatives.

20. The method of claim 19, wherein the frames comprise a plurality of macroblocks and the coding information comprises information whether the macroblocks in the frames are inter-coded or intra-coded and wherein the DC images are obtained also based on the coding information.

21. A device for use in a video coding component providing a video sequence in a compressed domain, the video sequence comprising a plurality of frames, said device comprising:
a first device part, responsive to video sequence in the compressed domain, for providing DC images of at least part of said plurality of frames;
a second device part, responsive to the DC images, for obtaining histograms of the DC images based on changed parts of the frames;
a third device part, responsive to the histograms, for computing the absolute sum of histogram difference between different DC images so as to identify a scene change in the video sequence at least partly based on the absolute sum of histogram difference.

22. The device of claim 21, wherein the video sequence is obtained from a compressed codestream, and wherein the changed parts of the frames are identified based on coding information from the compressed domain.

23. The device of claim 22, wherein the frames comprise a plurality of macroblocks and the coding information comprises information indicating whether the macroblocks in the frames are inter-coded or intra-coded.

24. The device of claim 21, wherein the absolute sum of histogram difference is computed based on DC images of adjacent frames in the video sequence.

25. The device of claim 23, wherein the scene change comprises a scent cut, and the third device part comprises means for applying a sliding window on the absolute sum of histogram difference over a number of consecutive frames in said plurality of frames for identifying the scene cut.

26. The device of claim 23, wherein the third device part also computes the absolute sum of pixel difference between different DC images so that said identifying is also based on the absolute sum of pixel difference.

27. The device of claim 26, wherein the absolute sum of histogram difference and the absolute sum of pixel difference are computed based on DC images of adjacent frames in the video sequence.

28. The method of claim 27, wherein the scene change comprises a scene cut, and said identifying comprises applying a sliding window on the absolute sum of histogram difference and a sliding window on the absolute sum of pixel difference over a number of consecutive frames in said plurality of frames for identifying the scene cut.

29. The method of claim 27, wherein the scene change comprises a gradual scene change, and said identifying comprises:
computing the change of the histogram differences over a number of frames; and
detecting the gradual scene change in said number of frames based on the change of the histogram differences.
